(19) United States
(12) Patent Application Publication
(10) Pub. No.: US 2026/0073622 A1
(43) Pub. Date: Mar. 12, 2026

(54) WORLD TRACKED PLANES FROM VOLUMETRIC GEOMETRY

(71) Applicant: Snap Inc., Santa Monica, CA (US)

(72) Inventors: Tobias Maier, Vienna (AT); Jakob Zillner, Absdorf (AT); Olha Borys, Vienna (AT)

(21) Appl. No.: 18/883,305

(22) Filed: Sep. 12, 2024

(51) Int. Cl. G06T 15/10; G06T 7/50; G06T 15/08; G06T 19/00

(52) U.S. Cl. CPC G06T 15/10; G06T 7/50; G06T 15/08; G06T 19/006

(57) ABSTRACT

A system is disclosed, including a processor and a memory. The memory stores instructions that, when executed by the processor, configure the system to perform operations. Depth estimates are used to generate distance values by applying a signed distance function to the depth estimates. A 3D representation of the environment is generated using the distance estimates. Local planes are fit to the 3D representation, and larger planes are generated by merging local planes using predefined criteria such as surface normal agreement. Larger planes are dynamically updated or removed in response to updated depth estimates.

### BACKGROUND

Augmented reality (AR) involves the presentation of virtual content to a user such that the virtual content appears to be attached to, or to otherwise interact with, a real-world physical object. Presentation of virtual content in AR can therefore be enhanced by accurate estimation of the locations, orientations, and dimensions of real-world physical objects in the user's environment.

The orientation of an AR device (e.g., AR glasses) can be determined using various techniques, e.g., using data generated by an inertial measurement unit (IMU) of the AR device. Once the orientation of an AR device is known, and given additional data regarding real-world objects in the environment, such as optical sensor data and/or depth sensor data, various techniques have been developed to determine or estimate the locations, orientations, and/or dimensions of those objects. One such technique is disclosed in U.S. patent application Ser. No. 17/747,592, filed 2022 May 18, and published as US 2022/0375112 A1, entitled “Continuous surface and depth estimation”. In the disclosed technique, a color camera image of the environment in front of an AR device is used to determine the distance (i.e., depth) to a surface in front of the AR device. Thus, the disclosed technique provides an efficient, accurate means of estimating the orientation and location of a surface plane in the user's environment, relying only on commonly-used and versatile optical sensors such as color cameras.

Other known techniques include the use of depth sensors such as Light Detection and Ranging (LIDAR) sensors to estimate the various characteristics of surfaces in the environment. However, such techniques tend to be computationally expensive and require specialized depth sensors. These limitations can be particularly salient in the context of AR devices, which tend to be small in size to allow for their easy use by users, and may therefore have limited available computing hardware and sensors.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a block diagram of an AR device configured to detect planes in an AR environment, according to some examples.

FIG. 2 is a block diagram of the plane detection system of the AR device of FIG. 1.

FIG. 3 is a flowchart showing operations of a method for detecting planes in an augmented reality environment, according to some examples.

FIG. 4 is perspective view of a real-world scene with planar surfaces being detected by an AR device in accordance with the method of FIG. 3.

FIG. 5 is an example unit of space-efficiently representing the environment as used in accordance with the method of FIG. 3.

FIG. 6 is an example scene for detecting planes within a space-efficient representation of the real-world scene of FIG. 4 in accordance with the method of FIG. 3.

FIG. 7 is a flowchart showing operations of an example method for detecting planes within a 3D representation of an AR environment, according to some examples.

FIG. 8 is an example of planes detected within the 3D representation of FIG. 6 in accordance with the method of FIG. 7.

FIG. 9 is an example of an enhanced AR experience in accordance with the method of FIG. 3.

FIG. 10 is a diagrammatic representation of a machine in the form of a computer system within which a set of instructions may be executed to cause the machine to perform any one or more of the methodologies discussed herein, according to some examples.

FIG. 11 is a block diagram showing a software architecture within which examples may be implemented.

### DETAILED DESCRIPTION

The present disclosure relates to a system and method for detecting planar surfaces in an augmented reality (AR) environment. The system comprises an AR device equipped with at least one camera and an inertial measurement unit (IMU). The AR device utilizes visual inertial odometry (VIO) to estimate the device's trajectory and orientation based on data collected from the camera and IMU.

An environment data module generates depth estimates and depth maps from the camera images and VIO data. The system employs a truncated signed distance function (TSDF) module to represent the 3D space. This module divides the 3D space into voxels and arranges groups of voxels into blocks. For each voxel, the TSDF module assigns distance values to the nearest surface ranging from −1 to 1 for each voxel, with 0 representing the actual surface. This representation allows for efficient processing and updating of the 3D environment data.

The system fits local planes to voxel blocks using least squares fitting. Subsequently, the local planes are merged into larger surfaces based on the agreement of their surface normals. In some examples, the system includes a plane updating module, which dynamically updates and removes planes as the environment changes.

The method begins by capturing image data and IMU data using the AR device. The VIO module then estimates the device's trajectory and orientation based on this captured data. Depth maps are generated from the captured image data and VIO data. The system creates a TSDF representation of the 3D space by dividing it into voxels, arranging these voxels into blocks, and assigning distance values to the nearest surface for each voxel.

The method proceeds with fitting local planes to voxel blocks using least squares fitting. These local planes are then merged into larger surfaces based on the agreement of their surface normals. The method also dynamically updates and remove planes as updates to camera images and VIO data indicate changes to the environment.

The detected planes serve multiple purposes in AR applications. They can be used for occlusion handling, allowing virtual objects to be hidden behind detected planes, thus enhancing the realism of the AR experience. Additionally, the detected planes can enable physics-based interactions with virtual objects in the AR environment, further improving the immersion and functionality of AR applications.

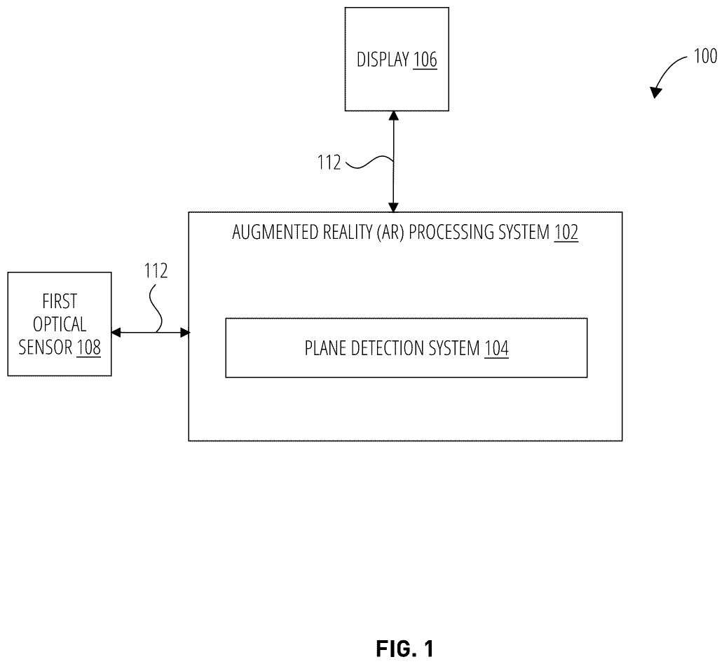

FIG. 1 shows a block diagram of an AR device 100 configured to detect planes in an AR environment. The AR device 100 provides functionality to augment the real-world environment of a user. For example, the AR device 100 allows for a user to view real-world objects in the user's physical environment along with virtual content to augment the user's environment. In some examples, the virtual content may provide the user with data describing the user's surrounding physical environment, such as presenting data describing nearby businesses, providing directions, displaying weather information, and the like.

The virtual content may be presented to the user based on the distance and orientation of the physical objects in the user's real-world environment. For example, the virtual content may be presented to appear overlaid on a surface of a real-world object. As an example, virtual content describing a recipe may be presented to appear overlaid over the surface of a kitchen counter. As another example, virtual content providing directions to a destination may be presented to appear overlaid on the surface of a path (e.g., street, ground) that the user is to follow to reach the destination.

In some embodiments, the AR device 100 may be a mobile device, such as a smartphone or tablet, that presents real-time images of the user's physical environment along with virtual content. Alternatively, the AR device 100 may be a wearable device, such as a helmet or glasses, that allows for presentation of virtual content in the line of sight of the user, thereby allowing the user to view both the virtual content and the real-world environment simultaneously.

As shown, the AR device 100 includes a first optical sensor 108 and a display 106 connected to and configured to communicate with an AR processing system 102 via communication links 112. The communication links 112 may be either physical or wireless. For example, the communication links 112 may include physical wires or cables connecting the first optical sensor 108 and display 106 to the AR processing system 102. Alternatively, the communication links 112 may be wireless links facilitated through use of a wireless communication protocol, such as Bluetooth™.

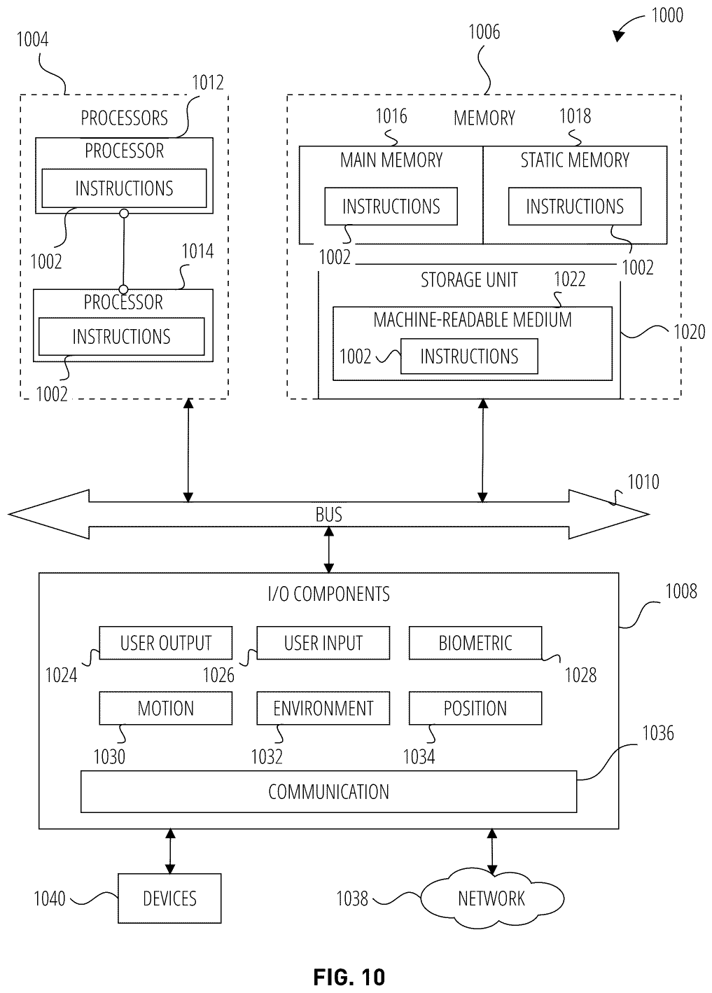

Each of the first optical sensor 108, display 106, and AR processing system 102 may include one or more devices capable of network communication with other devices. For example, each device can include some or all of the features, components, and peripherals of the machine 1000 shown in FIG. 10.

The first optical sensor 108 may be any type of sensor capable of capturing image data. For example, the first optical sensor 108 may be a camera, such as a color camera, configured to capture images and/or video. The images captured by the first optical sensor 108 are provided to the AR processing system 102 via the communication links 112.

The display 106 may be any of a variety of types of displays capable of presenting virtual content. For example, the display 106 may be a monitor or screen upon which virtual content may be presented simultaneously with images of the user's physical environment.

Alternatively, the display 106 may be a transparent display that allows the user to view virtual content being presented by the display 106 in conjunction with real world objects that are present in the user's line of sight through the display 106.

The AR processing system 102 is configured to provide AR functionality to augment the real-world environment of the user. For example, the AR processing system 102 generates and causes presentation of virtual content on the display 106 based on the physical location of the surrounding real-world objects to augment the real-world environment of the user. The AR processing system 102 presents the virtual content on the display 106 in a manner to create the perception that the virtual content is overlaid on a physical object. For example, the AR processing system 102 may generate the virtual content based on a determined surface plane that indicates a location (e.g., defined by a depth and a direction) and surface normal of a surface of a physical object. The depth indicates the distance of the real-world object from the AR device 100. The direction indicates a direction relative to the AR device 100, e.g., as indicated by a pixel coordinate of the image captured by one of the optical sensors 108, 110, which corresponds to a known angular displacement from a central optical axis of the optical sensor. The surface normal is a vector that is perpendicular to the surface of the real-world object at a particular point. The AR processing system 102 uses the surface plane to generate and cause presentation of the virtual content to create the perception that the virtual content is overlaid on the surface of the real-world object, with the virtual content located and oriented to with a specific relationship to an edge of the surface of the real-world object.

The AR processing system 102 includes a plane detection system 104. The plane detection system 104 obtains information about the environment, determines a 3D representation of the environment, and detects surface planes within the 3D representation.

The plane detection system 104 provides data defining the determined surface plane to the AR processing system 102. In turn, the AR processing system 102 may use the determined surface plane to generate and present virtual content that (i) appears to be overlaid on the surface plane, (ii) appears to be occluded by the surface plane, and/or (iii) appears to be interacting with a user of the user device while overlaid on the surface plane.

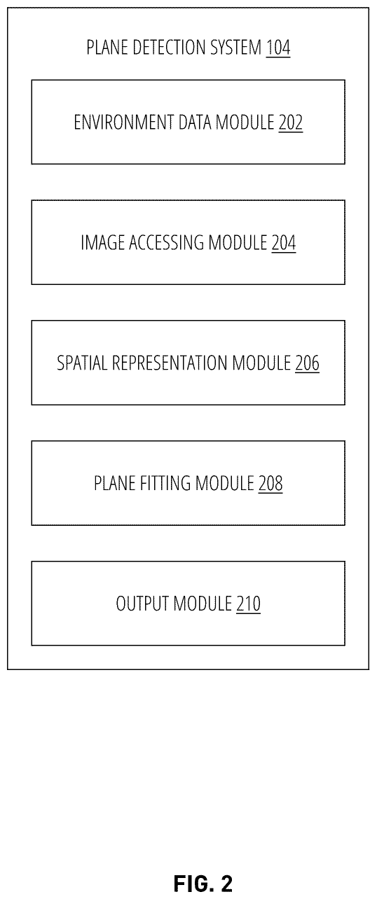

FIG. 2 is a block diagram of a plane detection system 104 according to some examples. A skilled artisan will readily recognize that various additional functional components may be supported by the plane detection system 104 to facilitate additional functionality that is not specifically described herein. The various functional modules depicted in FIG. 2 may reside on a single computing device or may be distributed across several computing devices in various arrangements such as those used in cloud-based architectures.

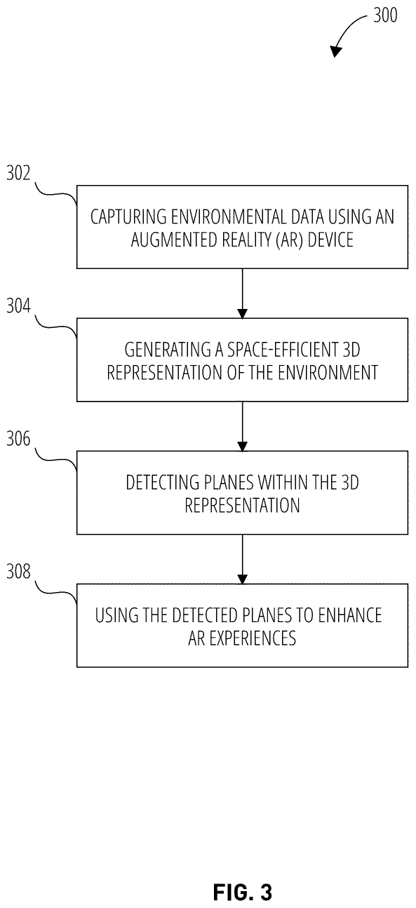

As shown, the plane detection system 104 includes an environment data module 202, an image accessing module 204, a spatial representation module 206, a plane fitting module 208, and an output module 210. The operation of these modules is described in detail below with reference to method 300 of FIG. 3. However, a functional summary of these modules is described immediately below.

The environment data module 202 is configured to generate or otherwise obtain information about the environment, such visual inertial odometry (VIO) data. The environment data module 202 is also configured to combine multiple sources of information, such as VIO data and image data, to generate depth maps.

In some examples, the environment data module 202 obtains the VIO data from sources other than the optical sensors 108, 110. For example, the VIO data can be received via a communication link from another device.

The environment data module 202, as well as the spatial representation module 206 and the output module 210 described below, relay on pose data for the AR device 100 to relate the images generated by the optical sensors (or other sensors, such as depth sensors) to data representations of the spatial environment of the AR device 100, such as surface plane information, 3D line representations, and so on. The pose data can be generated by position components 1034 described below with reference to FIG. 10, such as an inertial measurement unit (IMU) including one or more accelerometers. The pose data can also include a spatial model of the relationship between the optical sensors (and/or other sensors) and the other parts of the AR device 100, such as display 106. The spatial model allows the field of view of the sensors to be mapped to the display for accurate presentation of virtual content on the display having a specific spatial relationship with image content captured by the sensors.

The image accessing module 204 retrieves images from the optical sensors 108, 110. The images captured by each optical sensor 108, 110 may be retrieved continuously in real time and processed to perform the functions of the additional modules described below.

The spatial representation module 206 processes the depth maps generated by environment data module 202 (by combining images retrieved by the image accessing module 204 with VIO data) to generate a computationally efficient 3D representation of the environment. One representation used by spatial representation module 206 is a truncated signed distance function applied to a voxel grid.

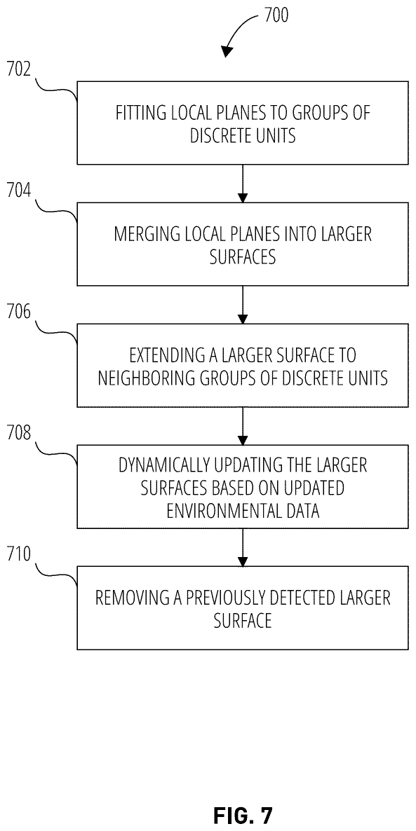

The plane fitting module 208 performs a routine (such as method 700 of FIG. 7) to determine planes within the 3D representation generated by spatial representation module 206. The plane fitting module 208 can fit local planes to groups of voxels. The plane fitting module 208 can additionally compare surface normals of the local planes to merge local planes into larger planes. The plane fitting module 208 can refine larger planes, for example at boundaries of a wall and floor, based on sampled points of the larger planes. The plane fitting module 208 can provide the environment data module 202 and the spatial representation module 206 with points sampled from the larger planes, for example to refine the plane fitting routine.

The output module 210 provides data defining the determined 3D surface planes to the AR processing system 102. In turn, the AR processing system 102 may use the determined 3D surface plane to generate and present virtual content that appears to be overlaid on the surface of the object and aligned with, or otherwise having a specific spatial relationship to, the 3D surface plane.

FIG. 3 shows operations of an example method 300 for detecting planes in an augmented reality environment. The method 300 provides an example of how the plane detection system 104 can generate 3D plane information from environmental data and captured images.

Although the example method 300 depicts a particular sequence of operations, the sequence may be altered without departing from the scope of the present disclosure. For example, some of the operations depicted may be performed in parallel or in a different sequence that does not materially affect the function of the method 300. In other examples, different components of an example device or system that implements the method 300 may perform functions at substantially the same time or in a specific sequence.

According to some examples, the method 300 includes capturing environmental data using an AR device, for example using environment data module 202 and/or image accessing module 204, at operation 302. In some examples, capturing environmental data includes capturing image data and inertial measurement unit (IMU) data. In some examples, the environmental data can be used to generate a plurality of depth estimates at operation 302. The plurality of depth estimates can be generated from one or more datasets, such as a series of posed camera images and/or a dataset of visual inertial odometry (VIO) points. It will be appreciated that a number of different depth estimation techniques can potentially be used in combination with the plane detection techniques described herein, which use a plurality of depth estimates to detect planes in an image, as described below. Any suitable depth estimation technique can be used at operation 302 to generate depth estimates.

The depth estimates generated at operation 302 can be in the form of a depth map, where each pixel in the camera image is assigned a distance. This depth map can be visually represented using a color scheme, such as blue indicating close proximity and red indicating greater distance. The depth estimates and depth map can be continuously updated with each additional posed camera image captured by the camera.

According to some examples, the method 300 includes generating a space-efficient 3D representation of the environment at operation 304. In some examples, the method 300 can use spatial representation module 206 at operation 304. In some examples, a space-efficient 3D representation of the environment is any suitable representation that divides the environment into discrete units and stores distance values to nearest surfaces.

In some examples, operation 304 includes determining a plurality of distance values by applying a signed distance function to the plurality of depth estimates from operation 302. In some examples, operation 304 includes configuring a voxel representation of the plurality of distance values.

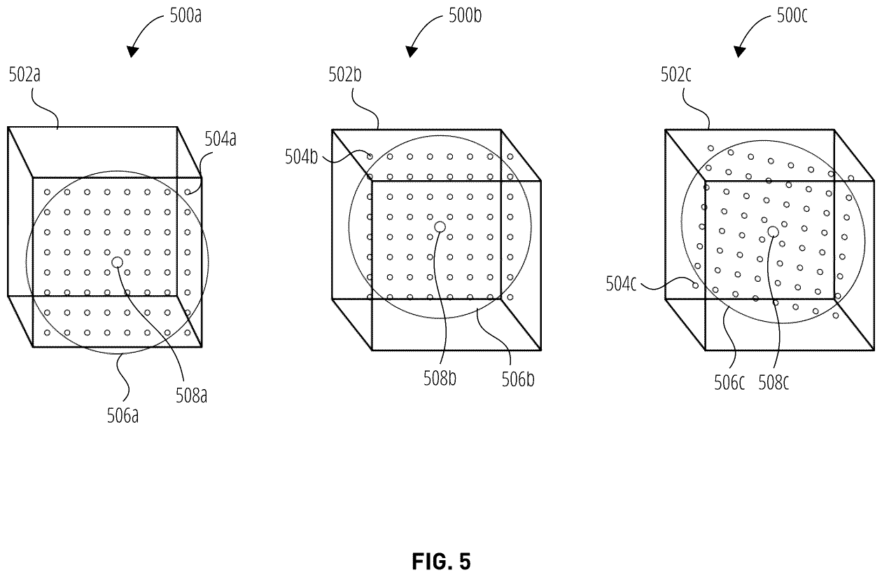

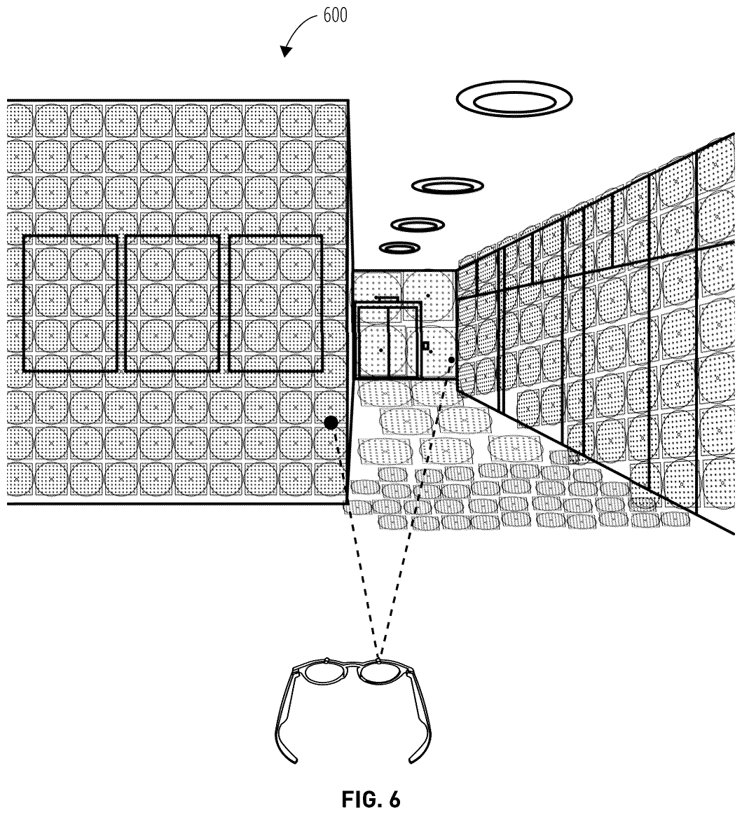

In some examples, operation 304 includes dividing the environment into discrete units. In some examples, the space-efficient 3D representation is a truncated signed distance function (TSDF) representation, wherein the TSDF representation comprises voxels organized into blocks. In some examples, a voxel representation includes each voxel having an associated distance value to the nearest surface. In some examples, discrete unit 500a (as described in FIG. 5 below, and as shown used in a hallway scene 600 in FIG. 6) can be used at operation 304.

In some examples, at operation 304, the discrete units of the 3D representation can be of uniform size. In some examples, at operation 304, the discrete units of the 3D representation can have varying sizes, for example, based on their distance from the AR device. In this example, discrete units that are closer to the AR device can be smaller while discrete units that are farther from the AR device can be larger. As a particular example, discrete units within 1 meter of the AR device can have a size of 1 cm; discrete units between 1 and 3 meters from the AR device can have a size of 5 cm; and discrete units beyond 3 meters from the AR device can have a size of 10 cm.

According to some examples, the method 300 includes detecting planes within the 3D representation at operation 306. In some examples, the method 300 can use plane fitting module 208 at operation 306. In some examples, any suitable method, such as method 700, can be used to detect planes within the 3D representation. In some examples, the operation 306 includes dynamically updating the detected planes based on new environmental data. In some examples, dynamically updating comprises removing a previously detected plane when updated environmental data indicates the plane no longer exists in the environment.

In some examples, at operation 306, detecting planes within the 3D representation can include generating coordinates for each of the detected planes. In some examples, the detected planes can be 3D planes and can be identified using a 3D coordinate system. In some examples, at operation 306, the method 300 can generate one or more of the following: the centroid/center point of the detected plane, the (oriented) extents of the detected plane oriented along its largest dimension, a convex hull of the detected plane (for every voxel block that is part of the edge of the plane, the method 300 can create a vertex; the method 300 then connects these vertices with a line to form an outline of the plane called a “hull” of the plane). In some examples, operation 306 can use plane fitting module 208 to sample points from the detected planes. In some examples, operation 306 can use output module 210 to provide data defining the determined 3D surface planes to the AR processing system 102.

According to some examples, the method 300 includes utilizing the detected planes to enhance AR experiences at operation 308. In some examples, the AR experiences can be enhanced by performing occlusion handling. That is, in some examples, the detected planes can be used to hide virtual objects. In some examples, the AR experiences can be enhanced by enabling physics-based interactions between virtual objects and detected planes. For example, a virtual object such as a character can interact with a detected plane that represents a room wall by bouncing a second virtual object such as a ball against the detected plane, giving the appearance of bouncing the ball off the wall.

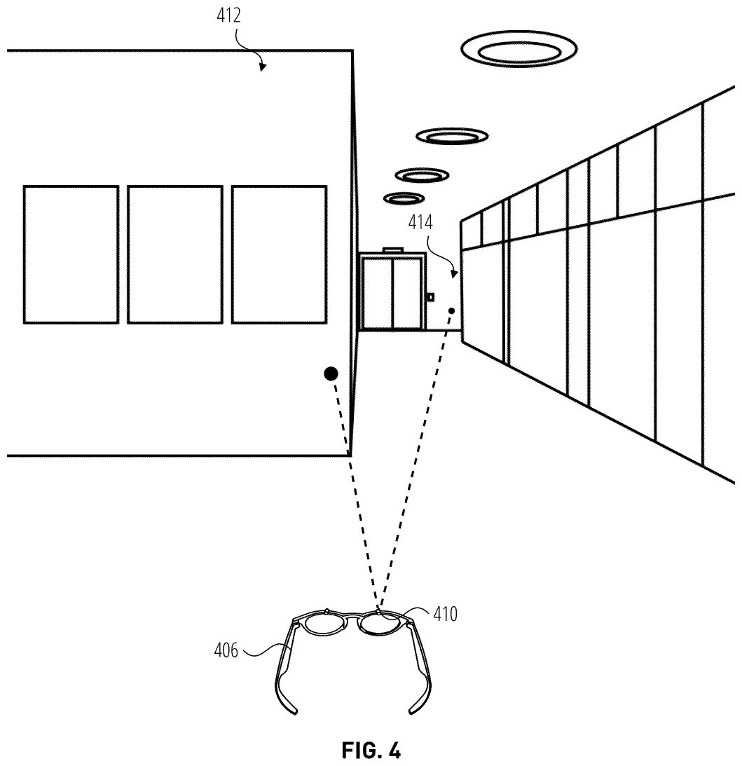

FIG. 4 shows an example of the AR device 100 as a head wearable apparatus head wearable apparatus 406, specifically a pair of AR glasses, performing the method 300 to detect planes in an augmented reality environment. The head wearable apparatus 406 has a first optical sensor 108 (shown as right camera 410). A real-world office hallway is visible in front of the head wearable apparatus 406.

At operation 302 of method 300, the images from right camera 410 are retrieved by image accessing module 204 and processed by the environment data module 202 to generate a series of posed camera images. As shown in FIG. 4, right camera 410 can image both a first planar surface 412 (i.e., a wall with framed art) and a second planar surface 414 (i.e., a wall at the end of the hallway), where the first planar surface 412 is closer to the head wearable apparatus 406 than the second planar surface 414.

FIG. 5 shows three examples of a discrete unit 500a, discrete unit 500b and discrete unit 500c of a 3D representation in accordance with the method 300 of FIG. 3. At operation 304 of method 300, a truncated signed distance function (TSDF) can be used to divide the three dimensional space into discrete units such as discrete unit 500a, 500b, and 500c.

As shown, discrete unit 500a includes a block 502a, at least one voxel 504a, a local plane 506a, and a surface normal 508a. As shown, discrete unit 500b includes a block 502b, at least one voxel 504b, a local plane 506a, and a surface normal 508b. Also shown in FIG. 5, discrete unit 500c includes a block 502c, at least one voxel 504c, a local plane 506c, and a surface normal 508c.

Note that in the example of FIG. 5, discrete unit 500a, 500b, and 500c are shown including the local plane and surface normals that are output from a method for detecting planes within a 3D representation of an AR environment, such as method 700. In some examples, a discrete unit can comprise any suitable portion of a 3D representation of an AR environment, such as the voxels and the groups of voxels (blocks) that are used as input to a method for detecting planes.

The TSDF representation, or any other suitable 3D representation, divides the three-dimensional space into discrete units called voxels, such as voxel 504a. Within each voxel, the TSDF assigns a distance value representing the proximity to the nearest surface. The TSDF allows for the continuous integration of multiple depth readings over time, averaging out noise and inaccuracies in individual depth measurements. The TSDF representation uses distance values ranging from −1 to 1 for each voxel, with 0 representing the actual surface. In some examples, any other representation can use distance values for each voxel that have any suitable value.

The voxels, which can be conceptualized as three-dimensional pixels, can be grouped into blocks, such as block 502a. In some examples, each block consists of 8×8×8 voxels, with individual voxels measuring 5 centimeters in size. The continuous integration of multiple depth readings can require a minimum threshold of depth readings (approximately 20) within a similar range to consider a block valid for plane fitting using a method such as method 700 described in connection with FIG. 7.

In some examples, voxels can be initialized dynamically based on the depth readings obtained from environment data module 202. As seen in discrete unit 500b and discrete units 500c, voxels such as voxel 504b and 504c are initialized in different locations throughout the block 502b and block 502c (respectively) depending on the depth readings and an indication of surfaces. Rather than pre-generating voxels throughout an entire block (to cover the entire potential space), the method 300 can initialize voxels and/or blocks only in areas where depth readings indicate the presence of surfaces. This approach can optimize memory usage and computational resources in AR device 100.

In some examples, local planes 506a, 506b, and 506c can be determined at operation 306 of the method 300. In some examples, the surface normal 508a can be used to merge multiple local planes into larger planes, as described at operation 306 of method 300. For example, operation 306 can include a similarity threshold when comparing surface normal 508a to either of surface normal 508b and surface normal 508c. Additionally or alternatively, operation 306 can include a root mean square error for fitting and/or merging local planes such as local plane 506a and 506b.

As shown in FIG. 5, the surface normals 508a-508c are represented as circles. In some examples, a surface normal can be a vector quantity and the circle representations of FIG. 5 can indicate a given point (such as a starting point and/or an ending point) to which the surface normal is perpendicular.

FIG. 6 shows an example of plane detection representation 600, that is, of head wearable apparatus 406 performing the method 300 and, in some examples, the method 700 of FIG. 7.

As shown in FIG. 6, a space-efficient 3D representation can use the discrete units 500a to represent surfaces in the real-world office hallway. For surfaces closer to head wearable apparatus 406, such as first planar surface 412, a smaller size of discrete units (smaller voxel grid, and/or smaller number of voxels per block) can be used. Similarly, for surfaces father from head wearable apparatus 406, such as second planar surfaces 414, a larger size of discrete units 500a (larger voxel grid, and/or larger number of voxels per block) can be used.

The variable voxel sizes can use three distinct zones based on the distance from the augmented reality device:
1. Close Range Zone: For areas within 1 meter of the device, the head wearable apparatus 406 utilizes voxels with a size of 1 centimeter. This high-resolution representation can allow for precise detection and modeling of nearby surfaces, and can provide accurate user interaction between virtual objects and the immediate physical environment.
2. Mid-Range Zone: In the region between 1 meter and 3 meters from the head wearable apparatus 406, the voxel size can increase to 5 centimeters. This intermediate resolution can provide a balance between detail and computational efficiency for surfaces at a moderate distance from the user.
3. Far Range Zone: For areas beyond 3 meters from the device, the head wearable apparatus 406 uses larger voxels with a size of 10 centimeters. This lower resolution for distant surfaces can help reduce computational load while still maintaining a useful representation of the broader environment.

This adaptive voxel sizing strategy allows head wearable apparatus 406 to allocate computational resources efficiently, focusing on detailed representation where it matters most—in the user's immediate vicinity—while maintaining a broader, less detailed representation of more distant areas. Although specific values have been listed above for the close range zone, mid-range zone, and far range zone above, the specific values can be adjusted for different AR applications in keeping with the distinct zones described.

FIG. 7 shows an example method 700 for detecting planes within a 3D representation of an AR environment. In some examples, method 700 can be performed as a sub-routine of any other suitable method, such as operation 306 of method 300. In some examples, method 700 can have access to any suitable data and information, such as the space-efficient 3D representation of the environment generated at operation 304.

Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence. Although method 700 is described as being performed by the plane detection system 104 of AR device 100, it will be appreciated that some examples will be performed using other devices, systems, or functional modules.

According to some examples, at operation 702, the method 700 includes fitting local planes to groups of discrete units that are generated as a space-efficient 3D representation of the environment. In some examples, blocks of voxels can be used to generate a local plane as shown in FIG. 5 and FIG. 6. For example, least squares fitting can be used to determine coordinates for a local plane for a particular block of voxels. In some examples, any suitable size of blocks can be used.

According to some examples, the method 700 includes merging local planes into larger surfaces based on predetermined criteria at operation 704. In some examples, the method includes generating a first larger plane from merging a first subset of the plurality of local planes based on the predefined criteria and generating a second larger plane from merging a second subset of the plurality of local planes based on the predefined criteria. In this example, the first subset is distinct from the second subset, and a first normal vector of the first larger plane is different from a second normal vector of the second larger plane.

In some examples, the predefined criteria includes a similarity threshold for surface normal vectors of the plurality of local planes and a root mean square error below a predetermined threshold. In some examples, the method 700 evaluates a similarity of surface normal vectors for agreement. For example, method 700 can determine an angle between a first surface normal vector and a second surface normal vector. Alternatively, the method 700 can determine a cosine similarity value between a first surface normal vector and a second surface normal vector. In either of these examples, a threshold can be used to determine that the angle, or the cosine similarity value, are in agreement.

Furthermore, the adaptive voxel sizing strategy discussed in FIG. 6 above has implications for the plane detection at operation 702, and merging local planes at operation 704. The method 700 can account for the varying levels of detail in different zones when fitting local planes and when merging them into larger surfaces. The method 700 can adjust thresholds and criteria for plane fitting and merging based on the resolution of the underlying voxel representation in each area.

According to some examples, the method 700 includes extending a larger surface established at operation 704 to neighboring groups of discrete units at operation 706.

At operation 706, the method 700 can refine larger surfaces determined at operation 704 by examining neighboring blocks and voxels, and by extending planes at a more granular level, such as extending a plane up to the precise boundary between surfaces. Additional local planes can be identified as neighboring a larger surface. Any suitable predefined criteria can be applied to the additional local planes to add the additional local planes to the larger surface or to reject the additional local planes from merging with the larger surface.

This iterative process allows for the identification and representation of extensive planar surfaces within the environment, such as walls, floors, and large flat objects. For example, at the boundaries between two intersecting planes, such as the corner where a wall meets the floor, the voxels contain mixed depth information from both planes.

According to some examples, the method 700 includes dynamically updating the larger surfaces based on updated environmental data at operation 708. In some examples, the method 700 can receive continuous updates of new depth readings and/or updates to the 3D representation of the environment. At operation 708, the updated depth readings and/or updated 3D representation of the environment can indicate that a new portion of a previously detected surface is within view of the AR device 100 and the method 700 can, for example, execute operation 706 to add local planes to the larger surface. Additionally or alternatively, at operation 708, the updated depth readings and/or updated 3D representation can indicate a new surface is within view of the AR device 100 and the method 700 can, for example, execute operation 702 and/or operation 704 to generate a larger surface that represents the new surface in view.

According to some examples, the method 700 includes removing a previously larger surface at operation 710, for example when updated environmental data indicates the plane no longer exists in the environment. In particular, if a larger surface no longer has sufficient number of local planes fitted to the larger surface, it may be removed or adjusted accordingly.

The dynamic updating described in operation 708 and operation 710 allows the AR device 100 to adapt to changes in the physical environment, ensuring that the virtual elements continue to interact correctly with the real world. For example, if a table is moved, method 700 can remove the plane representing its surface from the old location and can include a new plane at a new position of the table. Additionally, there is a temporal aspect to the dynamic updating. The method 700 can require multiple frames of new data before operation 708 can confidently update or operation 710 can remove a previously detected plane. This introduces a slight delay in adapting to sudden changes in the environment, which is a trade-off made to ensure the stability and reliability of the plane detection process.

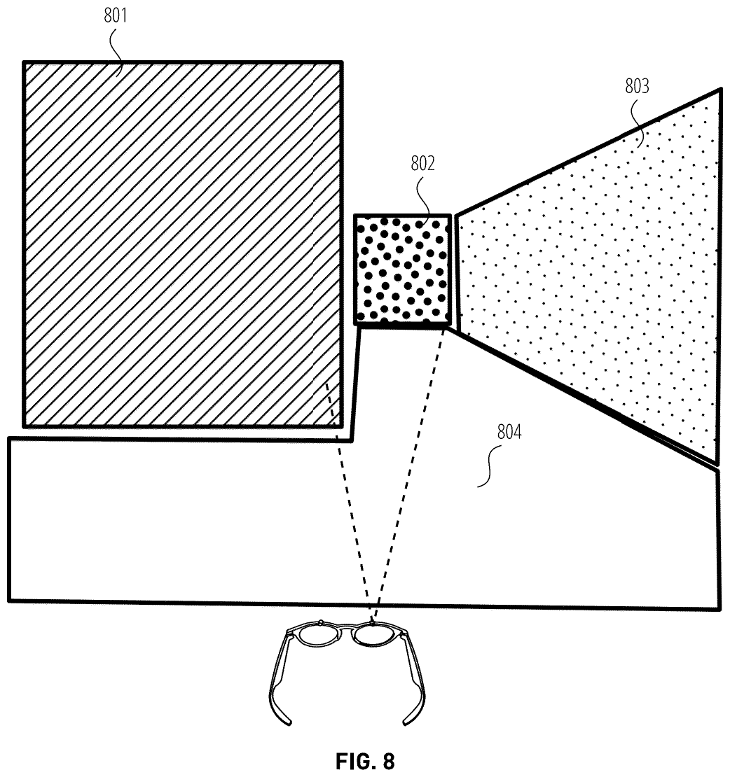

FIG. 8 shows an example of planes detected within the 3D representation of FIG. 6 in accordance with the method of FIG. 7. The method of FIG. 7 detected and calculated four planes in the real-world office hallway of FIG. 4: near wall 801, far wall 802, side wall 803, and floor 804.

In some examples, the AR experiences can be enhanced by sampling detected planes such as near wall 801 and far wall 802. The sampled points can be used to improve the accuracy of VIO data and depth estimates.

The VIO data generated in the environment data module 202 estimates points in three-dimensional space. In some examples, by processing the points from the detected planes to enhance the accuracy of the VIO data, the overall accuracy of data generated in environment data module 202 can be improved. As a particular example, VIO data can be projected onto nearby detected planes, such as near wall 801. Then, environment data module 202 can identify outliers in the VIO data that are inconsistent with near wall 801. Additionally, a portion of VIO data can be close to but not exactly on near wall 801, and environment data module 202 can adjust the positions of this portion of VIO data so that it aligns better with near wall 801.

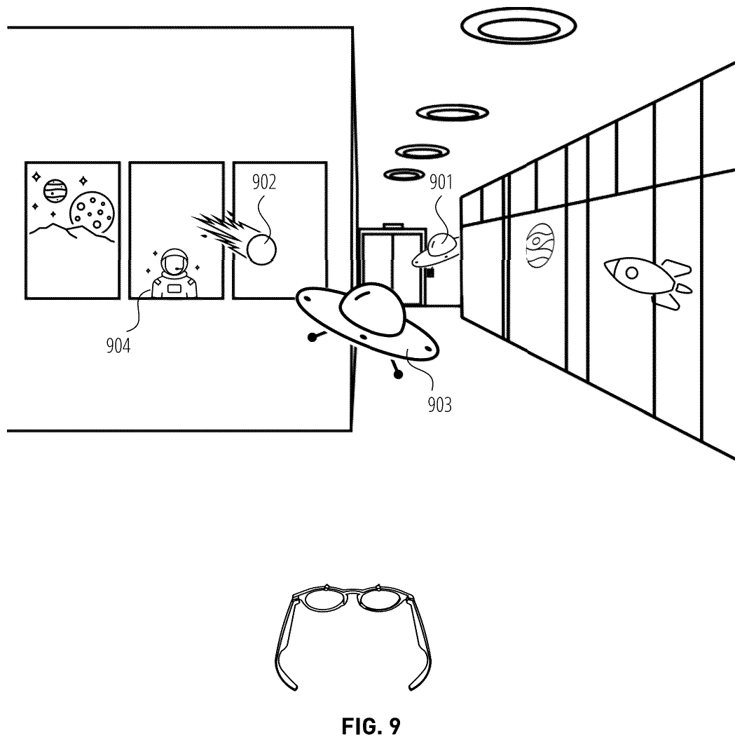

FIG. 9 shows an example of an enhanced AR experience in accordance with the method of FIG. 3.

Two applications of the detected planes are occlusion handling and physics-based interactions, both of which contribute to the realism and functionality of augmented reality experiences. Occlusion handling is a critical aspect of creating convincing augmented reality environments. It involves ensuring that virtual objects are correctly obscured by real-world objects when appropriate, maintaining the illusion that virtual elements exist within the physical space.

As shown in FIG. 9, augmented reality items 901-904 can be dispersed throughout the real-world office hallway. In particular, the far wall 802 and side wall 803 can be used to enhance the AR experience through occlusion handling. Spaceship 901 can be floating down the hallway and has turned the corner, so the AR device 100 can use the detected plane information to obscure a portion of the spaceship with the side wall 803. This creates a realistic integration of virtual and physical elements in the AR scene.

Physics-based interactions represent another application of the detected planes in augmented reality experiences. By leveraging the planar surfaces identified in the environment, AR device 100 can simulate realistic interactions between virtual objects and the physical world. This capability enables a wide range of interactive augmented reality applications and enhances the overall immersion of the experience.

As shown in FIG. 9, the near wall 801 can be used to create an illusion that comet 902 is coming out of the spaceship scene 904 depicted on the near wall 801 with a trajectory to intercept spaceship 903. Other examples of physics-based interactions where the detected planes can provide realistic integration includes collision detection and response for virtual objects. This allows virtual balls to bounce off real walls, virtual characters to walk on real floors, or virtual objects to rest on real tables. The planar representation of the environment provided by the plane detection method 700 is useful for these types of physics simulations, as it reduces the computational complexity compared to methods that use a triangle mesh representation of the 3D environment.

The implementation of physics-based interactions also benefits from operations 708 and 710 of method 700, that is, the ability to dynamically update the detected planes. As the user moves through the environment or as objects in the physical world are moved, the plane detection method 700 continuously refines its representation of the surroundings and ensures that physics-based interactions remain accurate and responsive to changes in the real-world environment.

### Machine Architecture

FIG. 10 is a diagrammatic representation of the machine 1000 within which instructions 1002 (e.g., software, a program, an application, an applet, an app, or other executable code) for causing the machine 1000 to perform any one or more of the methodologies discussed herein may be executed. For example, the instructions 1002 may cause the machine 1000 to execute any one or more of the methods described herein. The instructions 1002 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch, a pair of augmented reality glasses), a smart home device (e.g., a smart appliance), other smart devices, a web appliance, a network router, a network switch, a network bridge, or any machine capable of executing the instructions 1002, sequentially or otherwise, that specify actions to be taken by the machine 1000. Further, while a single machine 1000 is illustrated, the term “machine” shall also be taken to include a collection of machines that individually or jointly execute the instructions 1002 to perform any one or more of the methodologies discussed herein. In some examples, the machine 1000 may comprise both client and server systems, with certain operations of a particular method or algorithm being performed on the server-side and with certain operations of the particular method or algorithm being performed on the client-side.

The machine 1000 may include processors 1004, memory 1006, and input/output I/O components 1008, which may be configured to communicate with each other via a bus 1010. In an example, the processors 1004 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1012 and a processor 1014 that execute the instructions 1002. The term “processor” is intended to include multi-core processors that may comprise two or more independent processors (sometimes referred to as “cores”) that may execute instructions contemporaneously. Although FIG. 10 shows multiple processors 1004, the machine 1000 may include a single processor with a single-core, a single processor with multiple cores (e.g., a multi-core processor), multiple processors with a single core, multiple processors with multiples cores, or any combination thereof.

The memory 1006 includes a main memory 1016, a static memory 1018, and a storage unit 1020, both accessible to the processors 1004 via the bus 1010. The main memory 1006, the static memory 1018, and storage unit 1020 store the instructions 1002 embodying any one or more of the methodologies or functions described herein. The instructions 1002 may also reside, completely or partially, within the main memory 1016, within the static memory 1018, within machine-readable medium 1022 within the storage unit 1020, within at least one of the processors 1004 (e.g., within the processor's cache memory), or any suitable combination thereof, during execution thereof by the machine 1000.

The I/O components 1008 may include a wide variety of components to receive input, provide output, produce output, transmit information, exchange information, capture measurements, and so on. The specific I/O components 1008 that are included in a particular machine will depend on the type of machine. For example, portable machines such as mobile phones may include a touch input device or other such input mechanisms, while a headless server machine will likely not include such a touch input device. It will be appreciated that the I/O components 1008 may include many other components that are not shown in FIG. 10. In various examples, the I/O components 1008 may include user output components 1024 and user input components 1026. The user output components 1024 may include visual components (e.g., a display such as the display 106, a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the motion components 1030 include acceleration sensor components (e.g., accelerometer), gravitation sensor components, rotation sensor components (e.g., gyroscope).

The environmental components 1032 include, for example, one or more cameras (with still image/photograph and video capabilities) such as first optical sensor 108, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), depth sensors (such as one or more LIDAR arrays), or other components that may provide indications, measurements, or signals corresponding to a surrounding physical environment.

With respect to cameras, the machine 1000 may have a camera system comprising, for example, front cameras on a front surface of the machine 1000 and rear cameras on a rear surface of the machine 1000. The front cameras may, for example, be used to capture still images and video of a user of the machine 1000 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the machine 1000 may also include a 360° camera for capturing 360° photographs and videos.

Further, the camera system of the machine 1000 may include dual rear cameras (e.g., a primary camera as well as a depth-sensing camera), or even triple, quad or penta rear camera configurations on the front and rear sides of the machine 1000. These multiple cameras systems may include a wide camera, an ultra-wide camera, a telephoto camera, a macro camera, and a depth sensor, for example.

The position components 1034 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1008 further include communication components 1036 operable to couple the machine 1000 to a network 1038 or devices 1040 via respective coupling or connections. For example, the communication components 1036 may include a network interface component or another suitable device to interface with the network 1038. In further examples, the communication components 1036 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1040 may be another machine or any of a wide variety of peripheral devices (e.g., a peripheral device coupled via a USB).

Moreover, the communication components 1036 may detect identifiers or include components operable to detect identifiers. For example, the communication components 1036 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1036, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and memory of the processors 1004) and storage unit 1020 may store one or more sets of instructions and data structures (e.g., software) embodying or used by any one or more of the methodologies or functions described herein. These instructions (e.g., the instructions 1002), when executed by processors 1004, cause various operations to implement the disclosed examples.

The instructions 1002 may be transmitted or received over the network 1038, using a transmission medium, via a network interface device (e.g., a network interface component included in the communication components 1036) and using any one of several well-known transfer protocols (e.g., hypertext transfer protocol (HTTP)). Similarly, the instructions 1002 may be transmitted or received using a transmission medium via a coupling (e.g., a peer-to-peer coupling) to the devices 1040.

### Software Architecture

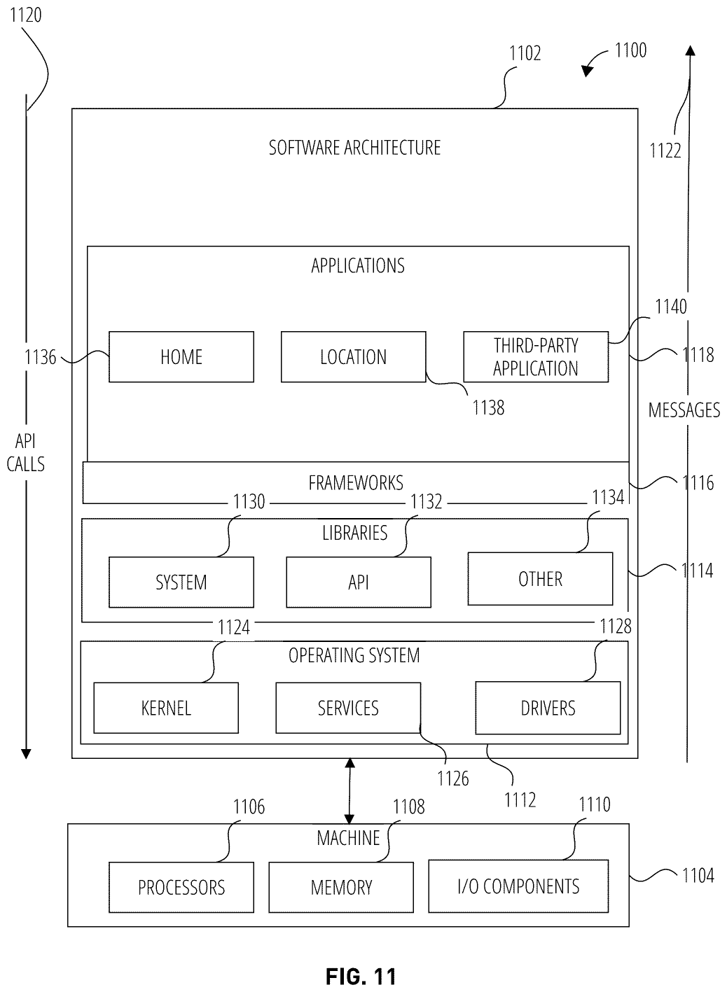

FIG. 11 is a block diagram 1100 illustrating a software architecture 1102, which can be installed on any one or more of the devices described herein. The software architecture 1102 is supported by hardware such as a machine 1104 that includes processors 1106, memory 1108, and I/O components 1110. In this example, the software architecture 1102 can be conceptualized as a stack of layers, where each layer provides a particular functionality. The software architecture 1102 includes layers such as an operating system 1112, libraries 1114, frameworks 1116, and applications 1118. Operationally, the applications 1118 invoke API calls 1120 through the software stack and receive messages 1122 in response to the API calls 1120. The AR processing system 102 and plane detection system 104 thereof may be implemented by components in one or more layers of the software architecture 1102.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1114 provide a common low-level infrastructure used by the applications 1118. The libraries 1114 can include system libraries 1130 (e.g., C standard library) that provide functions such as memory allocation functions, string manipulation functions, mathematic functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the applications 1118.

The frameworks 1116 provide a common high-level infrastructure that is used by the applications 1118. For example, the frameworks 1116 provide various graphical user interface (GUI) functions, high-level resource management, and high-level location services. The frameworks 1116 can provide a broad spectrum of other APIs that can be used by the applications 1118, some of which may be specific to a particular operating system or platform.

In an example, the applications 1118 may include a home application 1136, a location application 1138, and a broad assortment of other applications such as a third-party application 1140. The applications 1118 are programs that execute functions defined in the programs. Various programming languages can be employed to create one or more of the applications 1118, structured in a variety of manners, such as object-oriented programming languages (e.g., Objective-C, Java, or C++) or procedural programming languages (e.g., C or assembly language). In a specific example, the third-party application 1140 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1140 can invoke the API calls 1120 provided by the operating system 1112 to facilitate functionalities described herein.

### GLOSSARY

“Augmented reality” (AR) refers, for example, to an interactive experience of a real-world environment where physical objects that reside in the real-world are “augmented” or enhanced by computer-generated digital content (also referred to as virtual content or synthetic content). AR can also refer to a system that enables a combination of real and virtual worlds, real-time interaction, and 3D registration of virtual and real objects. A user of an AR system perceives virtual content that appear to be attached or interact with a real-world physical object.

“2D” refers to two-dimensional objects or spaces. Data may be referred to as 2D if it represents real-world or virtual objects in two-dimensional spatial terms. A 2D object can be a 2D projection or transformation of a 3D object, and a 2D space can be a projection or transformation of a 3D space into two dimensions.

“3D” refers to three-dimensional objects or spaces. Data may be referred to as 3D if it represents real-world or virtual objects in three-dimensional spatial terms. A 3D object can be a 3D projection or transformation of a 2D object, and a 3D space can be a projection or transformation of a 2D space into three dimensions.

“Line” refers to a line or line segment defined by at least two colinear points defined in a 2D or 3D space.

“Plane”refers to a 2D surface spanned by two independent lines.

“Surface normal” refers to a vector perpendicular to a surface at a given point on the surface.

“3D line” refers to a line or line segment defined in a 3D space. The 3D space can be a data representation of a 3D space or a real-world 3D space.

“3D point” refers to a point defined in a data representation of a 3D space or a real-world 3D space.

“Voxel” refers to a 3D pixel representing a value on a regular grid in 3D space. A “block”refers to a group of voxels.

“Depth map” refers to an image (typically a 2D image) where each pixel represents the distance from the camera to the corresponding point in the scene.

“Posed image” refers to a camera image associated with a position and an orientation of the camera and/or device at the time of capturing the camera image.

“Posed depth” refers to a depth map associated with a position and an orientation of the camera and/or device at the time of capturing data used to compute the depth map.

A “position” refers to spatial characteristics of an entity such as a virtual object, a real-world object, a line, a point, a plane, a ray, a line segment, or a surface. A position can refers to a location and/or an orientation of the entity.

A first location “associated with” an object or a second location refers to the first location having a known spatial relationship to the object or second location.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems.

What is claimed is:

1. A method for detecting planes in an augmented reality environment, the method comprising:
generating a plurality of depth estimates from one or more of: a series of posed camera images and a dataset of visual inertial odometry (VIO) points;
determining a plurality of distance values by applying a signed distance function to the plurality of depth estimates;
configuring a voxel representation of the plurality of distance values;
fitting a plurality of local planes to blocks of voxels in the voxel representation, wherein each block comprises multiple voxels;
generating a first larger plane from merging a first subset of the plurality of local planes based on predefined criteria; and
generating a second larger plane from merging a second subset of the plurality of local planes based on the predefined criteria, wherein the first subset is distinct from the second subset, and wherein a first normal vector of the first larger plane is different from a second normal vector of the second larger plane.

2. The method of claim 1, wherein the method further comprises:
generating a plurality of updated depth estimates based on an update to one or more of:
the series of posed camera images and the dataset of VIO points;
determining a plurality of updated distance values by applying the signed distance function to the plurality of updated depth estimates;
updating the voxel representation with the plurality of updated distance values; and
removing at least one of the first larger plane and the second larger plane based at least on updates to the voxel representation.

3. The method of claim 2, wherein the method further comprises:
fitting a plurality of updated local planes to blocks of voxels in the updated voxel representation; and
generating a third larger plane from merging a first subset of the plurality of updated local planes based on the predefined criteria.

4. The method of claim 1, wherein determining the plurality of distance values by applying the signed distance function to the plurality of depth estimates comprises:
continuously generating additional plurality of depth estimates based on continuous updates to one or more of: the series of posed camera images and the dataset of VIO points; and
averaging the additional plurality of depth estimates into the voxel representation.

5. The method of claim 1, wherein the signed distance function is a truncated signed distance function.

6. The method of claim 1, wherein generating the first larger plane from merging the first subset of the plurality of local planes comprises a comparison of a surface normal vector of each local plane with a neighboring local plane.

7. The method of claim 1, wherein the predefined criteria comprise at least one of a similarity threshold for surface normal vectors of the plurality of local planes and a root mean square error below a predetermined threshold.

8. The method of claim 1, wherein a block of voxels used in fitting the plurality local planes to blocks of voxels in the voxel representation comprises 8×8×8 voxels.

9. The method of claim 1, wherein a size of a block of voxels used in fitting the plurality of local planes to blocks of voxels is based on a distance in the voxel representation.

10. The method of claim 9, wherein the size of the block of voxels is larger than 8×8×8 voxels when the distance in the voxel representation is above a first threshold.

11. The method of claim 9, wherein the size of the block of voxels is smaller than 8×8×8 voxels when the distance in the voxel representation is below a second threshold.

12. The method of claim 1, further comprising:
extending the first larger plane to neighboring blocks of voxels when the neighboring blocks of voxels meet the predefined criteria.

13. The method of claim 1, further comprising sampling points from the first larger plane.

14. The method of claim 13, further comprising using the sampled points to improve accuracy of the dataset of VIO points.

15. The method of claim 13, further comprising using the sampled points to improve accuracy of the plurality of depth estimates.

16. A system for detecting planes in an augmented reality environment, the system comprising:
one or more processors;
a memory storing instructions that, when executed by the one or more processors, cause the system to perform operations comprising:
generating depth estimates from one or more of: a series of posed camera images and a dataset of visual inertial odometry (VIO) points;
generating distance values by applying a signed distance function to the depth estimates;
configuring a voxel representation of the distance values;
fitting local planes to blocks of voxels in the voxel representation, wherein each block comprises multiple voxels;
generating larger planes by merging one or more of the local planes based on predefined criteria; and
at least one of dynamically update or dynamically remove one or more of the larger planes in response to generating one or more updated depth estimates.

17. The system of claim 16, wherein the operations further comprise:
continuously generate additional depth estimates based on continuous updates to one or more of: the series of posed camera images and the dataset of VIO points; and
averaging the additional depth estimates into the voxel representation.

18. The system of claim 16, wherein the predefined criteria comprise at least one of a similarity threshold for surface normal vectors of the local planes and a root mean square error below a predetermined threshold.

19. The system of claim 16, wherein the operations further comprise:
sampling points from at least one of the larger planes; and
using the sampled points to improve at least one of: accuracy of the dataset of VIO points and accuracy of the depth estimates.

20. A non-transitory computer-readable storage medium, the computer-readable storage medium including instructions that when executed by a processor of a system, cause the system to perform operations comprising:
generating a plurality of depth estimates from one or more of: a series of posed camera images and a dataset of visual inertial odometry (VIO) points;
determining a plurality of distance values by applying a signed distance function to the plurality of depth estimates;
configuring a voxel representation with the plurality of distance values;
fitting a plurality of local planes to blocks of voxels in the voxel representation, wherein each block comprises multiple voxels;
generating a first larger plane from merging a first subset of the plurality of local planes based on predefined criteria;
generating a second larger plane from merging a second subset of the plurality of local planes based on the predefined criteria, wherein the first subset is distinct from the second subset, and wherein a first normal vector of the first larger plane is different from a second normal vector of the second larger plane; and
at least one of dynamically updating or dynamically removing one or more of the first larger plane and the second larger plane in response to generating one or more updated depth estimates.
